(19) United States
(12) Patent Application Publication
(10) Pub. No.: US 2013/0262191 A1
(43) Pub. Date: Oct. 3, 2013

(54) Systems and methods for measuring and scoring engagement in organizations

(71) Applicant: APTIFY CORPORATION, Tysons Corner, VA (US)

(72) Inventor: Amith Nagarajan, Metaire, LA (US)

(73) Assignee: Aptify Corporation, Tysons Corner, VA (US)

(21) Appl. No.: 13/986,118

(22) Filed: Apr. 3, 2013

Related U.S. Application Data
(60) Provisional application No. 61/619,527, filed on Apr. 3, 2012.

(51) Int. Cl. G06Q 10/06

(52) U.S. Cl. CPC G06Q 10/06393
USPC 705/7.39

(57) ABSTRACT

The illustrative embodiments relate generally to monitoring engagement, and more particularly, the illustrative embodiments relate to systems and methods for measuring and scoring engagement in organizations. Key performance indicators are selected and normalized. A composite engagement score is then determined.

### CROSS-REFERENCE TO RELATED APPLICATION

This application claims the benefit of U.S. Provisional Application No. 61/619,527, filed Apr. 3, 2012.

### TECHNICAL FIELD

The illustrative embodiments relate generally to monitoring engagement, and more particularly, the illustrative embodiments relate to systems and methods for measuring and scoring engagement in organizations.

### BACKGROUND

Member engagement is not a new term in Association Management. However, with the growth of new channels of communication on the Internet, and specifically with social media, organizations and associations may find engagement a challenging concept to grasp, let alone measure and track. As such, engagement models are continually changing and will likely continue to change at an even more rapid pace than they ever have before.

Engagement is one way to describe the relationship between an organization or association and its members because engagement occurs if there is a mutual exchange of value. Effective association executives have been mastering engagement with their members since the advent of the membership model. Growth in membership, events, volunteerism, foundation support, and more are all tied to the creation of value for the member. Of course, engagement creates value for the association, as well as, in many cases, it also creates value for the general public through a stronger profession or trade. Engagement may be seen as an intangible asset, much like the value of a brand. However, engagement has never been quantified in a consistent way in the Association Management profession. Therefore, there exists a significant need for a reliable and consistent system and method for measuring and scoring engagement in organizations.

### SUMMARY

In one embodiment, a composite engagement score system comprises: a memory configured to store a set of instructions; and a processor configured to execute the set of instructions, wherein the set of instructions cause the processor to: receive one or more key performance indicators; weigh the one or more key performance indicators in accordance with a predetermined level of importance for each key performance indicator relative to the other key performance indicators; translate each of the weighted key performance indicators into a normalized point value; and calculate a composite engagement score by adding the normalized point values for each key performance indicator together.

In another embodiment, a composite engagement score system comprises: a memory configured to store a set of instructions; and a processor configured to execute the set of instructions, wherein the set of instructions cause the processor to: receive a first key performance indicator; receive a second key performance indicator; receive a maximum normalized point value for the first key performance indicator; receive a maximum normalized point value for the second key performance indicator; receive a first criteria for determining a normalized point value for the first key performance indicator based on performance, wherein the determined normalized point value is in a range from zero to the maximum normalized point value for the first key performance indicator; receive a second criteria for determining a normalized point value for the second key performance indicator based on performance, wherein the determined normalized point value is in a range from zero to the maximum normalized point value for the second key performance indicator; receive performance data; determine a first normalized point value based on the performance data and the first criteria; determine a second normalized point value based on the performance data and the second criteria; calculate a composite engagement score by adding the first and second normalized point values together.

In yet another embodiment, a computer readable storage medium having stored thereon computer executable instructions which, when executed by a processor of a computing system, implement a method comprises: receiving a first key performance indicator; receiving a second key performance indicator; receiving a maximum normalized point value for the first key performance indicator; receiving a maximum normalized point value for the second key performance indicator; receiving a first criteria for determining a normalized point value for the first key performance indicator based on performance, wherein the determined normalized point value is in a range from zero to the maximum normalized point value for the first key performance indicator; receiving a second criteria for determining a normalized point value for the second key performance indicator based on performance, wherein the determined normalized point value is in a range from zero to the maximum normalized point value for the second key performance indicator; receiving performance data; determining a first normalized point value based on the performance data and the first criteria; determining a second normalized point value based on the performance data and the second criteria; calculating a composite engagement score by adding the first and second normalized point values together.

### BRIEF DESCRIPTION OF THE DRAWINGS

The drawings, when considered in connection with the following description, are presented for the purpose of facilitating an understanding of the subject matter sought to be protected.

FIG. 1 is a flow diagram illustrating a method for calculating a composite engagement score in a system.

FIG. 2 is a chart illustrating the weighing of key performance indicators.

FIG. 3 is a first graph illustrating a relationship between performance data and a composite engagement score point total for a particular KPI (number of events attended).

FIG. 4 is a second graph illustrating a relationship between performance data and a composite engagement score point total for a particular KPI (average annual revenue).

FIG. 5 is a third graph illustrating a relationship between performance data and a composite engagement score point total for a particular KPI (number of committees served on).

FIG. 6 is a schematic, block diagram of a data processing system in which the illustrative embodiments may be implemented.

### DETAILED DESCRIPTION

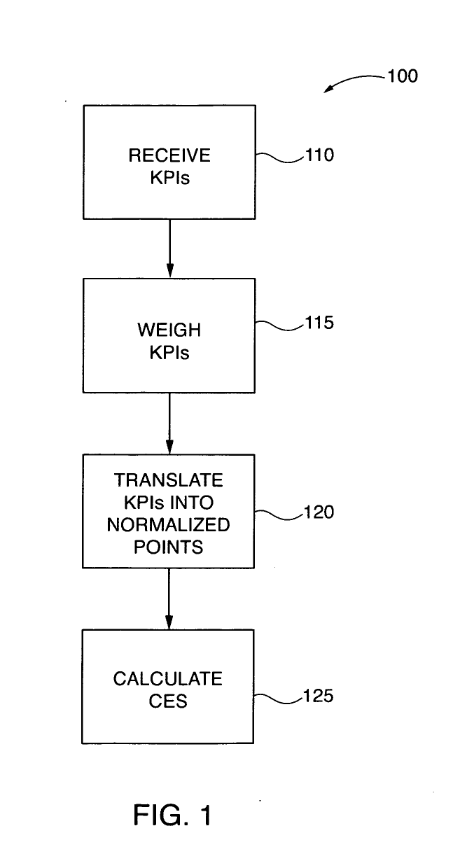

Referring now to FIG. 1, an illustrative method for calculating a Composite Engagement Score (CES) 100 in a computing device or system is shown. First, a set of key performance indicators (KPIs) are selected and received by the system [step 110]. The KPIs are selected so as to reflect an organization's goals in regards to an individual or organization's level of engagement with another individual, group, organization, etc.

Illustrative KPIs include, without limitation, the following: years of membership in the organization; membership level in the organization; percentage of the organization that is a member versus a non-member; number of referrals; number of committees served on over a period of time; number of hours spent working on a committee; impact created as a member of a committee; evaluations from co-members of a committee; voting as a member of a committee; use of affinity programs; total amount spent on affinity programs; number of affinity programs used over a period of time; total commission received from use of affinity program(s); number of volunteers hours; number of volunteer assignments; number of articles written (e.g. for blogs, newsletter, journals, magazines, etc.); number of forum posts; number of forum comments; number of comments posted on an other's article/post; number of speaking opportunities applied for; number of talks delivered; average speaking evaluation; number of events attended; number of event hours; social engagement including, but not limited to, number of tweets referencing an organization, retweets, number of tweets marked as favorites, number of links provided or shared in a social network (e.g. Google Plus, LinkedIn, private social network(s), etc.), number of references to an organization made in a social network, etc. It will be appreciated that any KPI may be measured over any suitable period of time (e.g. life-to-date, year-to-date, number of months, number of years, etc.). Further, it will be appreciated that the forgoing list of KPIs is illustrative in nature and that any suitable information or data set may be employed as a KPI and that the present disclosure is not limited to the forgoing. Also, in one embodiment, the number of KPIs selected and received is no more than five (5) KPIs. However, it will be appreciated that any suitable number of KPIs may be selected and remain within the scope of the present disclosure. Further, it will be appreciated that the KPIs may be changed over time as the organization's goals change and such that the CES best reflect the organization's current goals or vision.

Next, the KPIs are normalized so that the KPIs may be combined into a single measurement. The first step for normalizing the KPIs includes weighing the KPIs [step 115]. The KPIs are typically weighed in accordance with their importance relative to the other selected KPIs with the more important KPIs receiving a greater weight. Any suitable weighing technique may be employed and remain within the scope of the present disclosure. In one non-limiting example, each of the selected KPIs is given a weight of between 0 and 100. Also, a total weight of 100, or a total of 100 points, may be divided among the selected KPIs (and in accordance with their importance relative to the other selected KPIs). While a range of 100 points and a maximum of 100 points are described herein, it will be appreciated that the present disclosure is not limited to such a range or maximum and that any suitable value may be employed and remain within the scope of the present disclosure. Also, in one embodiment, the weight applied to any selected KPI is also representative of the maximum CES point total for that KPI. In one embodiment, the KPI weighting is received and/or displayed via a graphical-user interface.

Once the KPIs are weighed, a criteria for translating performance data associated with each KPI to a normalized point value is determined and received [step 120]. This is typically done by assigning a particular point value to a given KPI performance. The normalized point value associated with a particular KPI performance is typically representative of the importance the organization has placed on that level of performance. The normalized point value may be assigned in any suitable way, including but not limited to, a table or graphical interface may be used and/or manipulated by a user so as to map KPI performance data or information to a particular point value, one or more mathematical functions that receives the KPI performance input and translates the data to a normalized point value, or any other suitable means or technique for translating the KPI data or information to a normalized point value. Any suitable relationship between the KPI data and a point value for the KPI may be employed. For example, and without limitation, there may be an increasing, decreasing, parabolic, stepped, undulating or any other suitable relationship between KPI performance and the normalized point value. In an alternative, one or more ranges of KPI performance may be mapped to one or more point values. However, it will be appreciated that any suitable means or technique for translating data associated with KPI performance to a particular normalized point value may be employed and remain within the scope of the present disclosure. Further, as mentioned, in one embodiment, the maximum normalized point value for a particular KPI is the weight value previously given to the particular KPI.

Next, the CES is calculated by the system [step 125]. This is typically done by locating, mining or otherwise receiving performance data specific to the selected KPIs, translating the performance data to a normalized point value for each selected KPI in accordance with the criteria from step 120, and adding the normalized point values together wherein the sum is the CES. The CES may be calculated on any suitable level including, but not limited to, individual persons, certain segments within the organization, an organization as a whole or any other suitable level. For CES calculated at more of a macro level (e.g. certain segments of the organization—for example, geographic region, age, years in the profession, member types or class, or any other segment, the organization as a whole, etc.), KPIs that are more specific to a macro view may be selected, the CES for individuals within the segment or organization may be totaled and a statistical mean or median calculated, or a combination thereof. Additionally, CES may be determined on a real-time basis, at specific intervals, calculated based on past performance data or in any other suitable fashion. Additionally, the CES may provide powerful statistical data representative of an individual or organizations engagement where this CES statistical data may be employed, analyzed or manipulated in any relevant statistical or analytical means or method (e.g. trend analysis—for member, for certain segments, for the organization, etc., predictive modeling, identifying key performers, identifying poor performers, etc.).

An illustrative example of calculating a CES will now be provided. It will be appreciated that the following illustration is not to be considered limiting in any way. For this example, the following KPIs are selected:
(1) Total number of events attended (over the last 3 years);
(2) Average annual revenue to the organization (over the last 2 years); and
(3) Total number of committees served on (over the last 3 years).

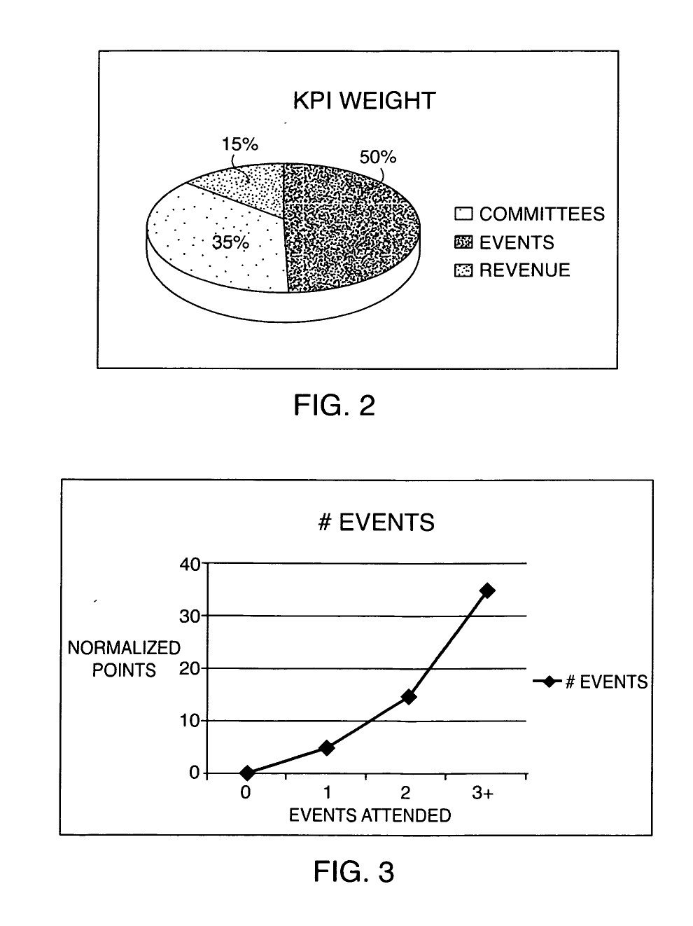

A total of 100 is distributed among the three selected KPIs such that the total number of committees served on over the last 3 years is given a weight of 50 points; the total number of events attended over the last 3 years is given a weight of 35 points; and the average revenue to the organization over the last 2 years is given a weight of 15 points. The KPI weighting for this example is illustrated graphically in FIG. 2.

The criteria for translating KPI performance data or information to a normalized point value is provided in the following tables.

For the total number of events attended (over the last 3 years):

| # of Events Attended | Normalized Point Value |
|---|---|
| 0 | 0 |
| 1 | 5 |
| 2 | 15 |
| 3+ | 35 |

FIG. 3 represents the above table in a graphical fashion. As will be apparent, the maximum normalized point value for this KPI is the same as the weight previously given to this KPI.

For the average annual revenue to the organization (over the last 2 years):

| Revenue/Year Average | Normalized Point Value |
|---|---|
| 0-400 | 0 |
| 400-1,000 | 3 |
| 1,000+ | 15 |

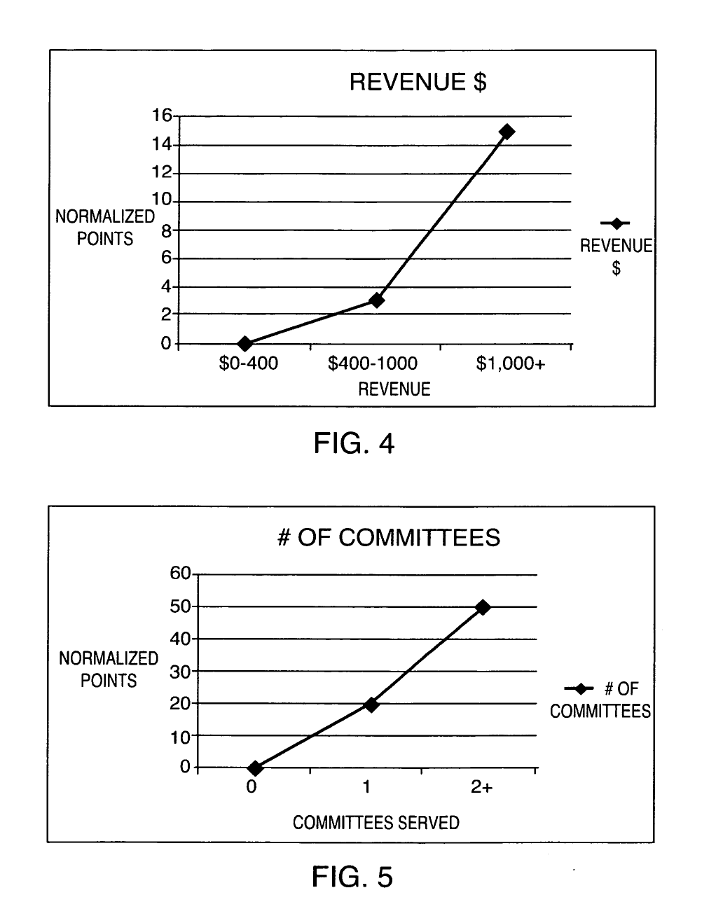

FIG. 4 represents the above table in a graphical fashion. As will be apparent, the maximum normalized point value for this KPI is the same as the weight previously given to this KPI.

For the total number of committees served on (over the last 3 years):

| # of Committees | Normalized Point Value |
|---|---|
| 0 | 0 |
| 1 | 20 |
| 2+ | 50 |

FIG. 5 represents the above table in a graphical fashion. As will be apparent, the maximum normalized point value for this KPI is the same as the weight previously given to this KPI.

As a point of emphasis, while the forgoing criteria illustrate an increasing point value as the KPI performance data increases and/or accelerates (up to a limit), it will be appreciated that the present disclosure is in no way limited to such an increasing and/or accelerating relationship. For example, and without limitation, a decreasing and/or decelerating relationship may be employed, a decreasing and/or decelerating relationship may be employed up to or after a certain point or limit may be employed, a flat relationship up to or after a certain point may be employed, a stepped relationship among certain ranges may be employed or any combination of increasing, accelerating, decreasing, decelerating, flat, stepped may be employed or any other suitable relationship may be employed and remain within the scope of the present disclosure.

For the example, an individual member has the following performance data associated with each of the selected KPIs:

Total Events Attended
2009—1
2010—2
2011—1
A total of 4 events attended during the past 3 years

Average Revenue to Organization
2010—$600
2011—$80
An average revenue amount of $340 per year over the past two years

Total # of Committees Served on for Last 3 Years
2009—0
2010—0
2011—1
Total—1

The normalized point value for each KPI may be determined in accordance with the prior criteria via the tables and/or graphs. The normalized point value for each KPI for the individual member are:

Total Events Attended Last 3 Years—4 Events maps to 35 points

Average Revenue—Last 2 Years—$340 maps to 0 points

Total # of Committees Served on—Last 3 Years—1 maps to 20 points

The CES is then calculated by summing the point values for each of the KPIs. Thus, for the individual member in this example, the CES is 55.

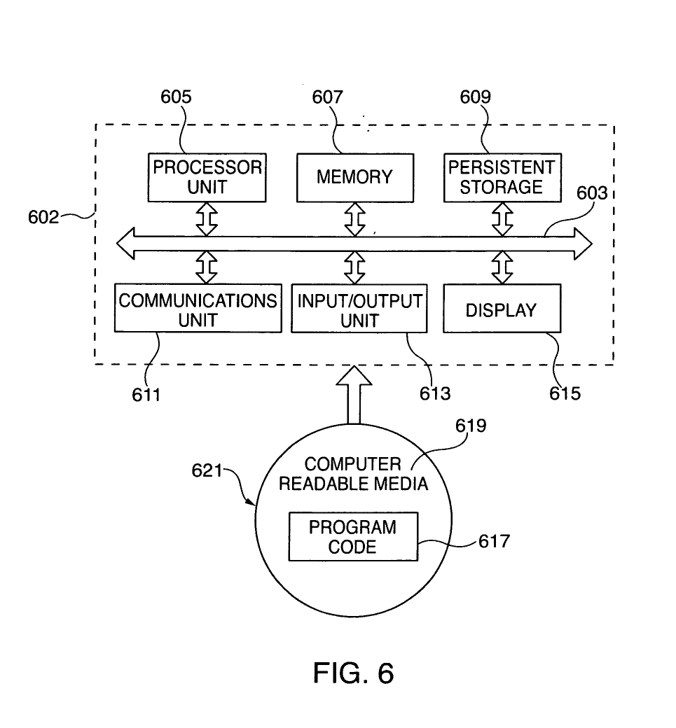

Referring now to FIG. 6, a block diagram of a computing device or system 602 is shown in which the illustrative embodiments of the CES system and determinations of a CES may be implemented. Computer-usable program code or instructions implementing the processes used in the illustrative embodiments may be located on the computing device 602. The computing device 602 includes a communications fabric 603, which provides communications between a processor unit 605, a memory 607, a persistent storage 609, a communications unit 611, an input/output (I/O) unit 613, and a display 615.

The processor unit 605 serves to execute instructions for software that may be loaded into or otherwise stored in the memory 607. The processor unit 605 may be a set of one or more processors or may be a multi-processor core, depending on the particular implementation. Further, the processor unit 605 may be implemented using one or more heterogeneous processor systems in which a main processor is present with secondary processors on a single chip. As another illustrative example, the processor unit 605 may be a symmetric multi-processor system containing multiple processors of the same type.

The memory 607, in these examples, may be, for example, a random access memory or any other suitable volatile or non-volatile storage device. The persistent storage 609 may take various forms depending on the particular implementation. For example, the persistent storage 609 may contain one or more components or devices. For example, the persistent storage 609 may be a hard drive, a flash memory, a rewritable optical disk, a rewritable magnetic tape, or some combination of the above. The media used by the persistent storage 609 also may be removable. For example, a removable hard drive may be used for the persistent storage 609. In one embodiment, the persistent storage may include one or more databases that contain or otherwise store performance data relative to one or more selected KPIs and accessible for query and/or data retrieval by the processor 605 and/or memory 607. However, it will be appreciated that such a database may be located in a different computing device or system and remain within the scope of the present disclosure.

The communications unit 611, in these examples, provides for communications with other data processing systems, communication devices and/or database(s). In these examples, the communications unit 611 may be a network interface card. The communications unit 611 may provide communications through the use of either or both physical and wireless communication links. In one embodiment, the communication unit is configured to provide a communications link between the device 602 and a storage device or media that includes one or more databases which contain or otherwise store performance data relative to one or more selected KPIs such that the one or more database(s) may be accessible for query by the device 602.

The input/output unit 613 allows for the input and output of data with other devices that may be connected to the computing device 602. For example, the input/output unit 613 may provide a connection for user input through a keyboard and mouse. Further, the input/output unit 613 may send output to a processing device. The display 615 provides a mechanism to display information to a user, such as a graphical user interface. The input/output unit and display may be connected directly to the device 602 or may be in communication with the device 602 through one or a series of other computing device or devices in communication with the device 602.

Instructions for the operating system and applications or programs are located on the persistent storage 609. These instructions may be loaded into the memory 607 for execution by the processor unit 605. The processes of the different embodiments may be performed by the processor unit 605 using computer-implemented instructions, which may be located in a memory, such as the memory 607. These instructions are referred to as program code, computer-usable program code, or computer-readable program code that may be read and executed by a processor in the processor unit 605. The program code in the different embodiments may be embodied on different physical or tangible computer-readable media, such as the memory 607 or the persistent storage 609.

Program code 617 is located in a functional form on a computer-readable media, or computer-readable storage media, 619 and may be loaded onto or transferred to the computing device 602 for execution by the processor unit 605. The program code 617 and the computer-readable media 619 form computer program product 621 in these examples.

In one example, the computer-readable media 619 may be in a tangible form, such as, for example, an optical or magnetic disc that is inserted or placed into a drive or other device that is part of the persistent storage 609 for transfer onto a storage device, such as a hard drive that is part of the persistent storage 609. In a tangible form, the computer-readable media 619 also may take the form of a persistent storage, such as a hard drive or a flash memory that is connected to the computing device 602. The tangible form of the computer-readable media 619 is also referred to as computer recordable storage media.

Alternatively, the program code 617 may be transferred to the computing device 602 from the computer-readable media 619 through a communication link to the communications unit 611 or through a connection to the input/output unit 613. The communication link or the connection may be physical or wireless in the illustrative examples. The computer-readable media 619 also may take the form of non-tangible media, such as communication links or wireless transmissions containing the program code 617. In one embodiment, the program code 617 is delivered to the computing device 602 over the Internet.

The different components illustrated for the computing device 602 are not meant to provide architectural limitations to the manner in which different embodiments may be implemented. The different illustrative embodiments may be implemented in a data processing system including components in addition to or in place of those illustrated for computing device 602. Other components shown in FIG. 6 can be varied from the illustrative examples shown.

As one example, a storage device in the computing device 602 is any hardware apparatus that may store data. The memory 607, the persistent storage 609, and the computer-readable media 619 are examples of storage devices in a tangible form.

In another example, a bus system may be used to implement the communications fabric 603 and may be comprised of one or more buses, such as a system bus or an input/output bus. Of course, the bus system may be implemented using any suitable type of architecture that provides for a transfer of data between different components or devices attached to the bus system. Additionally, the communications unit 611 may include one or more devices used to transmit and receive data, such as a modem or a network adapter. Further, a memory may be, for example, the memory 607 or a cache such as found in an interface and memory controller hub that may be present in the communications fabric 603.

The elements of each of the forgoing embodiment may have any suitable dimension and may be formed from any suitable material including, but not limited to, polymer, metal, composite, or any combination thereof. Also, while the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. It will further be appreciated that any singular portion or any suitable combination of the forgoing is expressly contemplated and that the present disclosure is not limited to a single embodiment including all of the forgoing.

What is claimed is:

1. A composite engagement score system comprising:
a memory configured to store a set of instructions; and
a processor configured to execute the set of instructions, wherein the set of instructions cause the processor to:
receive one or more key performance indicators;
weigh the one or more key performance indicators in accordance with a
predetermined level of importance for each key performance indicator relative to the other key performance indicators;
translate each of the weighted key performance indicators into a normalized point value; and
calculate a composite engagement score by adding the point values for each key performance indicator together.

2. The system of claim 1 wherein the one or more key performance indicator are each at least one member selected from a list comprising: number of years as a member; membership level; number of referrals; number of events attended over a predetermined period of time; total revenue from a member over a predetermined period of time; number of speaking engagements; number of committees served on; positions held on committees; and social network engagement.

3. The system of claim 1 wherein the key performance indicators are related to performance of an individual.

4. The system of claim 1 wherein the key performance indicators are related to the performance of an organization.

5. The system of claim 1 wherein the step of weighing the key performance indicators includes assigning each key performance indicator a point value between 1 and 100

6. The system of claim 5 wherein a total of 100 points in divided among all of the key performance indicators.

7. The system of claim 1 wherein the weighted key performance indicators are translated into normalized point values based on predetermined criteria.

8. A composite engagement score system comprising:
a memory configured to store a set of instructions; and
a processor configured to execute the set of instructions, wherein the set of instructions cause the processor to:
receive a first key performance indicator;
receive a second key performance indicator;
receive a maximum normalized point value for the first key performance indicator;
receive a maximum normalized point value for the second key performance indicator;
receive a first criteria for determining a normalized point value for the first key performance indicator based on performance, wherein the determined normalized point value is in a range from zero to the maximum normalized point value for the first key performance indicator;
receive a second criteria for determining a normalized point value for the second key performance indicator based on performance, wherein the determined normalized point value is in a range from zero to the maximum normalized point value for the second key performance indicator;
receive performance data;
determine a first normalized point value based on the performance data and the first criteria;
determine a second normalized point value based on the performance data and the second criteria;
calculate a composite engagement score by adding the first and second normalized point values together.

9. The system of claim 8 wherein each of the first and second key performance indicator are at least one member selected from a list comprising: number of years as a member; membership level; number of referrals; number of events attended over a predetermined period of time; total revenue from a member over a predetermined period of time; number of speaking engagements;
number of committees served on; positions held on committees; and social network engagement.

10. The system of claim 8 wherein the maximum normalized point value for the first key performance indicator is between 0 and 100.

11. The system of claim 8 wherein the maximum normalized point value for the second key performance indicator is between 0 and 100.

12. The system of claim 8 wherein the combined maximum normalized point value for the first and second key performance indicators is 100.

13. The system of claim 8 wherein the performance data is specific to one or more persons.

14. The system of claim 8 wherein the performance data is specific to an organization.

15. The system of claim 8 wherein the performance data is received from a database.

16. The system of claim 8 wherein the performance data is received from a database in response to a query.

17. A computer readable storage medium having stored thereon computer executable instructions which, when executed by a processor of a computing system, implement a method comprising:
receiving a first key performance indicator;
receiving a second key performance indicator;
receiving a maximum normalized point value for the first key performance indicator;
receiving a maximum normalized point value for the second key performance indicator;
receiving a first criteria for determining a normalized point value for the first key performance indicator based on performance, wherein the determined normalized point value is in a range from zero to the maximum normalized point value for the first key performance indicator;
receiving a second criteria for determining a normalized point value for the second key performance indicator based on performance, wherein the determined normalized point value is in a range from zero to the maximum normalized point value for the second key performance indicator;
receiving performance data;
determining a first normalized point value based on the performance data and the first criteria;
determining a second normalized point value based on the performance data and the second criteria;
calculating a composite engagement score by adding the first and second normalized point values together.

18. The method of claim 17 wherein the maximum normalized point value for the first key performance indicator is between 0 and 100.

19. The method of claim 17 wherein the maximum normalized point value for the second key performance indicator is between 0 and 100.

20. The method of claim 17 wherein the performance data is received from a database in response to a query.
